(19) United States
(12) Patent Application Publication
(10) Pub. No.: US 2015/0356180 A1
(43) Pub. Date: Dec. 10, 2015

(54) INFERRING RELATIONSHIP STATUSES OF USERS OF A SOCIAL NETWORKING SYSTEM

(71) Applicant: Facebook, Inc., Menlo Park, CA (US)

(72) Inventor: Ismail Onur Filiz, El Cerrito, CA (US)

(73) Assignee: Facebook, Inc., Menlo Park, CA (US)

(21) Appl. No.: 14/295,543

(22) Filed: Jun. 4, 2014

(51) Int. Cl. G06F 17/30

(52) U.S. Cl. CPC G06F 17/30867; G06F 17/3053; G06F 17/30876

(57) ABSTRACT

A social networking system infers a relationship status (e.g., single, married, in a relationship, etc.) of a user of the social networking system based on the user's interactions with additional users of the social networking system and the relationship statuses of the additional users. The social networking system identifies certain types of interactions between the user and additional users as indicators and determines a value for an indicator based on a number of additional users associated with the indicator that identify a relationship status of single and a number of additional users associated with the indicator that identify a relationship status other than single. Based on the values of various indicators, the social networking system determines a score for the user and infers a relationship status for the user based on the score.

### BACKGROUND

This disclosure relates generally to social networking systems, and in particular to inferring relationship statuses of users of a social networking system.

A social networking system allows users to connect to and communicate with other users of the social networking system. Users create profiles on a social networking system that are tied to their identities and include information about the users, such as interests and demographic information. The users may be individuals or entities such as corporations or charities.

Conventional social networking systems allow users to include information identifying their relationship status in their corresponding user profiles. For example, a user indicates its relationship status in its user profile as single, married, in a relationship, etc. However, conventional social networking systems do not require a user to provide relationship status when creating a user profile. Without receiving information from a user, conventional social networking systems are unable to identify the user's relationship status. Relationship status may be used for ranking certain search results.

### SUMMARY

To infer the relationship status of a social networking system user who has not provided a relationship status, a social networking system determines a set of indicators based on a user's interactions with additional users of the social networking system who have provided relationship status information. A relationship status is information provided by the user indicating whether the user is single or is not single. The social networking system identifies indicators from the user's interactions with additional users and calculates values associated with various indicators. A value associated with an indicator is based on a number of additional users associated with the indicator and specifying a relationship status of single and a number of additional users associated with the indicator and specifying a relationship status other than single. Example types of interactions identified as indicators include check-ins including the user and one or more additional users, accesses of additional users' user profiles by the user, tags or associations of the user and one or more additional users in a photo or other content posted to the social networking system, and requests by the user to establish connections with additional users.

The social networking system may also identify information associated with the user and determine additional values based on the identified information. Examples of additional information include: a number of users detected in a user's profile image, a percentage of additional users having a particular gender that are connected to the user, a frequency or a number of times a user performed one or more interactions with an additional user, etc. For example, the social networking system determines an additional value based on a percentage of users connected to a user that have an opposite gender than the user. As an additional example, the social networking system determines an additional value based on a number of check-ins in which a user and a specified additional user are tagged or otherwise identified.

Different weights may be associated with different values or additional values in various embodiments. For examples, an additional value based on check-ins associated with a user and with a distinct additional user are weighted proportionally to a number of check-ins associated with the user and the additional user. In this example, a single check-in associated with an additional user and the user has a lower weight than multiple check-ins associated with the user and a different additional user.

The social networking system trains one or more models using information associated with users who have declared their relationship statuses. Different models may be trained for users of different age groups, of different genders, in geographic locations, etc. For example, to train a model users of the social networking system indicating a relationship status of “in a relationship,” indicating a gender of male, indicating an age between 21 and 25, and indicating a location of California are identified, and the model is trained based on information associated with the identified users as well as interactions by the identified users with additional users. The model in the previous example is subsequently applied to users that have not specified a relationship status but have indicated a gender of male, an age between 21 and 25, and a location of California. Based on the values associated with indicators determined for a user, a model determines a score associated with the user, which is used to infer a relationship status is associated with the user. For example, different scores are associated with different relationship statuses.

In various embodiments, the social networking system may use a relationship status inferred for a user as a search parameter for additional users or as criteria for ranking search results presented to the user. For example, if a user's relationship status is inferred as “single,” search results associated with social networking system users having a relationship status of “single” are more prominently presented in a listing of search results. Additionally inferred relationship statuses may be used by advertisers for advertisement targeting. For example, an inferred relationship status associated with a user is compared to targeting criteria associated with an advertisement to determine if the user is eligible to be presented with the advertisement. For example, an advertisement for a dating service is associated with targeting criteria identifying users associated with a relationship status of “single,” and users associated with an inferred relationship status of “single” are identified as eligible to be presented with the advertisement.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flow chart of a method for inferring a relationship status associated with a social networking system user, in accordance with an embodiment.

FIG. 4 is an example of inferring a relationship status associated with a social networking system user, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

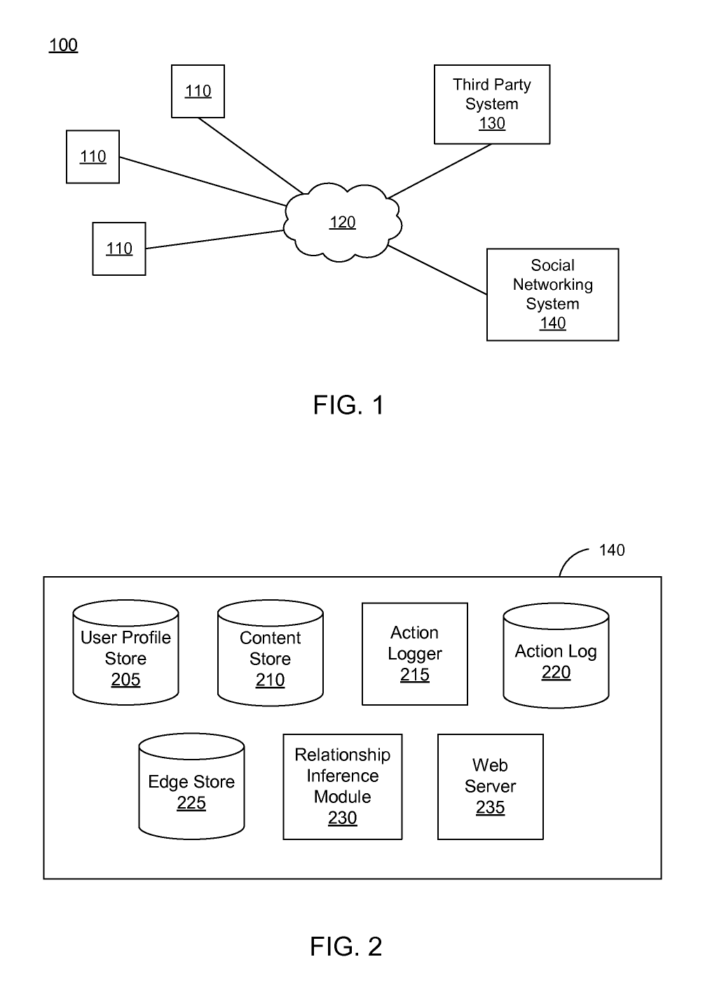

FIG. 1 is a block diagram of a system environment 100 for a social networking system 140. The system environment 100 shown by FIG. 1 comprises one or more client devices 110, a network 120, one or more third party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the social networking system 140, such as advertisements, content, or information about an application provided by the third party system 130.

FIG. 2 is a block diagram of an architecture of the social networking system 140. The social networking system 140 shown in FIG. 2 includes a user profile store 205, a content store 210, an action logger 215, an action log 220, an edge store 225, a relationship inference module 230, and a web server 235. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

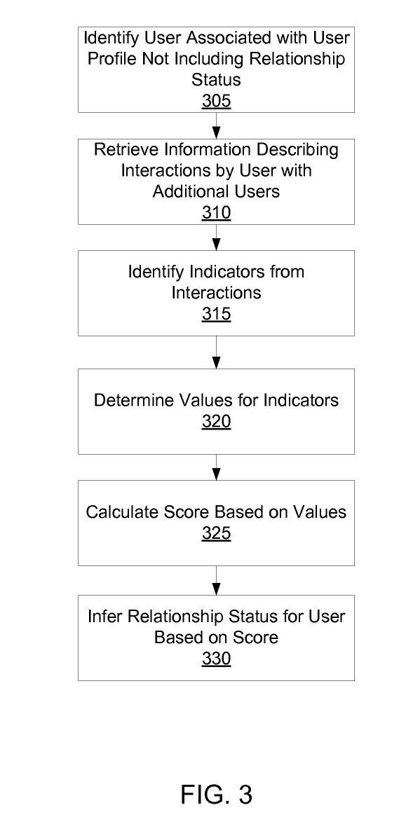

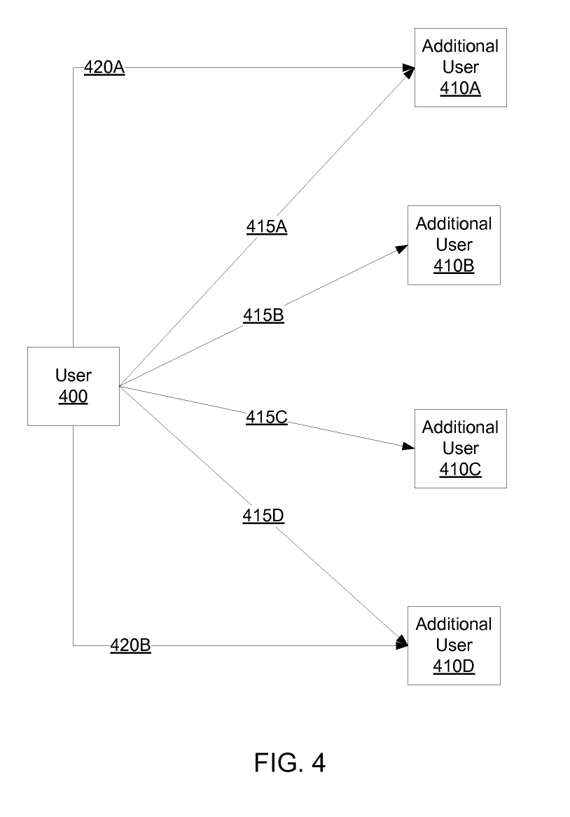

The user profile store 205 may include information associated with a relationship status of a user of the social networking system. A relationship status is information provided by the user indicating whether the user is single or is not single. For example, a user indicates in its user profile that the user single, married, in a relationship, or other suitable information describing a user-specified relationship with another user. A user may update the relationship status identified in its corresponding user profile to reflect the user's current relationship status. Additionally, the social networking system 140 may infer a relationship status associated with a user and store the inferred relationship status in the user's user profile, as further described below in conjunction with FIGS. 3 and 4.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140. In one embodiment, the content store 210 includes one or more user identifiers that identify one or more social networking system users presented with a content item that are stored in association with the stored content item.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The relationship inference module 230 identifies indicators of a relationship status associated with a user who has not provided a relationship status based on interactions performed by the user that are associated with additional social networking system users who have provided a relationship status. Additionally, the relationship inference module 230 may also retrieve additional information for inferring a user's relationship status from information associated with the user's user profile. To infer a relationship status for a user, the relationship inference module 230 identifies types of interactions by the user with additional users as indicators. Example interactions with additional users identified as indicators include requests to establish connections with additional users, accesses of user profiles associated with additional users, check-ins by the user to locations identifying one or more additional users, and messages sent to additional users (e.g., by instant message, notifications, etc.). Examples of additional information associated with the user's user profile retrieved by the relationship inference module 230 include existing connections to additional users, photos (or other content items) identifying the user and one or more additional users, a profile image, an age of the user, and a gender of the user.

Values associated with one or more indicators are determined by the relationship inference module 230. A value associated with an indicator is based on relationship statuses associated with additional users associated with the indicator. For example, an indicator's value is based on a number of additional users identifying a relationship status of single who are associated with the indicator as well as a number of additional users identifying a relationship status other than single who are associated with the indicator. Other information associated with the user and the additional user may also be used to compute the value associated with an indicator. For example, an indicator's value is based in part on a gender of the user and genders of additional users associated with an action associated with the indicator. In one embodiment, a value for an indicator (e.g., establishing a connection with an additional user) is based on a number of distinct additional users having a relationship status of single associated with the indicator, a number of distinct additional users having a relationship status other than single associated with the indicator, and a total number of times the indicator is associated with distinct additional users. Additional values may also be determined from information associated with a user's user profile. Examples of information associated with a user's user profile for determining an additional value include a total number of distinct additional users to which a user is connected, a number of distinct additional users of the opposite gender to which the user is connected, a number of distinct additional users to which the user is connected who are single, a number of distinct additional users to which the user is connected who are not single (e.g., married or in a relationship), and a number of users identified in the user's profile image. A value associated with an indicator may be indicated as a percentage, a frequency (i.e., interactions associated with an indicator occurring over a specified period of time), a ratio, or any other suitable expression.

Different values or additional values may be associated with different weights. For example, values associated with indicators or associated with additional values associated with user profile information indicating a user is in a relationship based on relationship statuses of additional users have negative weights, while values associated with indicators or associated additional values indicating the user is not in a relationship based on relationship statuses of additional users have positive weights. Certain indicators or additional information may be identified as strong indicators of a user's relationship status, so their values are associated with higher weights than weights associated with values of other indicators. For example, based on information in user profiles of users who identified relationship statuses and interactions by users who identified relationship statuses, likelihoods of interactions or user profile information being associated with a user having a specified relationship status are determined. A weight associated with a value associated with an indicator or associated with an additional value associated with information from a user's user profile is determined in part on the likelihood of the indicator or the additional value being associated with a user having a specified relationship status. For example, a value associated with the identification of two users in a user's profile image is weighted more heavily than a value associated with the detection of one face in a user's profile image if a threshold number or percentage of users with two users identified in their profile images have specified a relationship status indicating the users are not single.

In some embodiments, values associated with indicators or additional values may be discounted based on a relationship between a user and an additional user. For example, if the social networking system 140 receives information indicating a user and additional user are family members, values associated with indicators based on interactions between the user and the additional user are associated with different weights than indicators based on interactions between the user and additional users who are not indicated as the user's family members. As a specific example, if a user's profile image identifies a user and an additional user that is a family member of the user, an additional value based on the profile image identifying multiple users is associated with a lower weight than an additional value based on the profile image identifying the user and an additional user that is not a family member of the user. In another example, if an additional user is confirmed to be deceased, values associated with indicators based on a user's interactions with the additional user may be discounted. In one embodiment, values associated with indicators based on interactions with individuals who are not users of the social networking system are discounted. For example, if a user checks in to a location with an individual who is not a user of the social networking system, since information about the individual's age, gender, and relationship status cannot be retrieved, a value associated with an indicator based on the check-in is discounted.

The relationship inference module 230 calculates a score associated with a user's relationship status based on the values associated with the one or more indicators, and may account for additional values based on the user's user profile when calculating the score. In some embodiments, a machine-learned model is applied to the values to determine the score. For example, a machine-learned model is trained using interactions with additional users performed by users who have identified their relationship statuses. Additional values based on user profile information associated with users who have identified their relationship statuses may also be used to train the machine-learned model (e.g., gender, age, location). Different models may be trained for different demographic groups (e.g., age groups, genders, geographic locations, etc.) so that a model used to determine a score for a user is based on user profile information or interactions associated with other users having characteristics similar to those of the user.

Based on the score calculated for a user, the relationship inference module 230 infers a relationship status associated with the user. In one embodiment, a relationship status of single is inferred if the score is below a threshold value and a relationship status other than single is inferred if the score is above the threshold value. Different threshold values may be associated with different relationship statuses. Alternatively, the score is compared to multiple ranges of scores, with each range associated with a relationship status. A relationship status associated with a range including the score is then inferred for the user.

The web server 235 links the social networking system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the social networking system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, WEBOS® or BlackberryOS.

### Inferring a Relationship Status of a Social Networking System User

FIG. 3 is flow chart of one embodiment of a method for inferring a relationship status associated with a social networking system user. In other embodiments, the method includes different, additional, or fewer steps than those depicted by FIG. 3. The social networking system 140 identifies 305 a user of the social networking system associated with a user profile that does not include information identifying a relationship status, which indicates whether the user has declared a relationship status. In various embodiments, a relationship status indicates whether the user is single or is not single. For example, the social networking system 140 retrieves user profiles from the user profile store 205 and identifies a user associated with a user profile that does not include a relationship status.

For the identified user, the social networking system 140 retrieves 310 information describing one or more interactions of the user with one or more additional users of the social networking system 140. Information from the user profile associated with the user may also retrieved. For example, the user's gender, age, profile image, location, connections between the user and additional users, and content identifying the user and additional users are retrieved based on the user's user profile. The social networking system 140 may retrieve 310 information describing interactions of the user with one or more additional users and information from the user's user profile from the user profile store 205, the action log 220, and the edge store 225.

The social networking system 140 identifies 315 one or more types of interactions by the user as indicators. Specific types of interactions by the user that are also associated with additional users are identified 315 as indicators of the user's relationship status. Example types of interactions identified 315 as indicators include establishing a connection to an additional user, accessing a user profile of an additional user, identifying an additional user in association with content along with the user (e.g., tagging an additional user in an image, identifying the additional user in a group), and communicating a message to an additional user.

The social networking system 140 retrieves 320 information associated with additional users who are associated with the indicators and determines 325 values for various indicators based on the retrieved information associated with additional users who are associated with the various indicators. Examples of retrieved information associated with additional users include age, gender, location, and relationship status. In one embodiment, a value associated with an indicator is determined 325 based on relationship statuses of additional users associated with the indicator. For example, a value associated with an indicator is determined 325 based on a number of additional users indicating a relationship status of single associated with the indicator and a number of additional users indicating a relationship status other than single associated with the indicator. In some embodiments, a total number of additional users associated with the indicator may also be used to determine 325 the indicator's value. For example, a value for an indicator is determined 325 based on a percentage of additional users associated with the indicator that indicated a relationship status of single.

Values associated with an indicator may be expressed using numbers, percentages, frequencies, ratios, or any other suitable type of measurement. Characteristics of the additional users associated with an indicator may affect the indicator's value. For example, contributions of additional users associated with an indicator and identified as having a familial relationship with the user to the indicator's value are reduced relative to contributions of additional users associated with the indicator who do not have a familial relationship with the user.

Additional values may also be determined based on information retrieved from the user profile associated with the user. For example, values are determined based on a number of existing connections to additional users identifying a relationship status of single, a number of existing connections to additional users identifying a relationship status other than single, a number of additional users specifying a relationship status other than single identified in content along with the user, a number of additional users specifying a relationship status of single identified in content along with the user, an age of the user, and a gender of the user.

The social networking system 140 calculates 330 a score for the user based on the values determined for one or more indicators associated with the user. Additional values determined from user profile information associated with the user may also be used to calculate 330 the score for the user. For example, a machine-learned model may be used to calculate 330 a score based on the values associated with a user. The machine-learned model may be trained using information associated with other users who have declared their relationship statuses (e.g., information about the users' interactions with additional users and information about the gender and relationship statuses of the additional users). Different models may be trained for users associated with different demographic groups (e.g., age ranges, genders, geographic locations, etc.) so that the score calculated 330 for a user is based on information associated with other users having similar characteristics to the user. Values associated with different indicators or additional values may be associated with different weights, which are applied to the values or additional values when calculating 330 the score.

Based on the calculated store, the social networking system 140 infers 335 a relationship status for the user. In one embodiment, the score is compared to a threshold value, and the user's relationship status is inferred 335 as single if the score is above the threshold value and is inferred 335 to be other than single if the score is below the threshold value. In other embodiments, if the score is above a threshold value, the user's relationship status is inferred 335 to be other than single and is inferred 335 to be single if the score does not exceed the threshold value. Alternatively, the score may be compared to different ranges of scores that are each associated with a relationship status, and a relationship status associated with a range of scores including the score is inferred 335 for the user. In some embodiments, a relationship status inferred 335 for the user may be used to modify an order in which search results are presented to the user or for targeting advertisements to the user.

FIG. 4 shows an example of inferring a relationship status for a user of the social networking system 140. In the example of FIG. 4, the user 400 interacts with four additional users 410A, 410B, 410C, 410D, with additional users 410A, 410D associated with information specifying a relationship status of single and additional users 410B, 410C specifying a relationship status other than single. In this example, the user 400 accesses 415A, 415B, 415C, 415D user profiles associated with each of the four additional users 410A, 410B, 410C, 410D and identifies 425A, 425B additional users 410A, 410D specifying a relationship status of single in images that also include the user 400. Accessing 415A, 415B, 415C, 415D a user profile of an additional user 410 and identifying 420A, 420B an additional user 410 and the user 400 in content are identified as indicators in the example of FIG. 4.

For the indicator based on accessing 415A, 415B, 415C, 415D user profiles of additional users 410A, 410B, 410C, 410D, the social networking system 140 determines a value accounting for the number of additional users 410A, 410B, 410C, 410D specifying a relationship status of single whose profiles were accessed (2 in this example) and the number of additional users 410A, 410B, 410C, 410D specifying a relationship status other than single whose profiles were accessed (2 in this example). Similarly, for the indicator based on identifying 420A, 420B the user 400 and additional users 410A, 410B, 410C, 410D in content, a value is determined based on the number of additional users 410A, 410B, 410C, 410D specifying a relationship status of single identified 420A, 420B along with the user 400 in the content (2 in this example) and the number of additional users 410 specifying a relationship status other than single identified 420 along with the user 400 in the content (0 in this example). The values associated with the indicators identified in the example of FIG. 4 are combined to determine a score associated with the user 400, with the relationship status of the user 400 inferred based at least in part on the score.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
identifying a user of a social networking system associated with a user profile that does not include a relationship status indicating whether the user is single or is not single;
retrieving information describing one or more interactions by the user with one or more additional users of the social networking system;
identifying one or more types of interactions by the user with one or more additional users of the social networking system as one or more indicators;
determining values for each of the one or more indicators, a value for an indicator based at least in part on a number of additional users associated with the indicator and indicating a relationship status of single and a number of additional users associated with the indicator and indicating a relationship status of other than single;
calculating a score based at least in part on the determined values; and
inferring the relationship status associated with the user profile associated with the user based at least in part on the score.

2. The method of claim 1, wherein inferring the relationship status associated with the user profile associated with the user based at least in part on the score comprises:
comparing the score to a plurality of ranges of scores, each range of scores associated with a relationship status; and
inferring the relationship status associated with the user profile associated with the user as a relationship status associated with a range of scores including the score.

3. The method of claim 1, wherein the one or more types of interactions by the user are selected from a group consisting of: requesting to establish connections to one or more additional users, accessing user profile information associated with one or more additional users, sending a message to one or more additional users, and any combination thereof.

4. The method of claim 1, wherein calculating the score based at least in part on the values of each of the one or more indicators comprises:
retrieving the user profile associated with the user;
retrieving information from the user profile associated with the user;
generating one or more additional values based at least in part on the retrieved information from the user profile associated with the user; and
calculating the score based at least in part on the determined values and the one or more additional values.

5. The method of claim 4, wherein the information from the user profile associated with the user is selected from a group consisting of: one or more connections between the user and one or more additional users, content posted to the social networking system in which the user and one or more additional users are identified, relationship statuses associated with one or more additional users connected to the user, a number of users identified in a profile image associated with the user, an age associated with the user, and any combination thereof.

6. The method of claim 4, wherein the information from the user profile associated with the user is selected from a group consisting of: an age associated with the user, a gender associated with the user, one or more ages associated with one or more additional users, one or more genders associated with one or more additional users, one or more relationship statuses associated with one or more additional users, and any combination thereof.

7. The method of claim 1, wherein calculating the score based at least in part on the values of each of the one or more indicators comprises:
generating the score by applying a machine-learned model to the values of each of the one or more indicators.

8. The method of claim 7, wherein the machine-learned model is determined based at least in part on information included in the user profile associated with the user.

9. The method of claim 8, wherein the information included in the user profile is selected from a group consisting of: an age, a gender, and a location.

10. A method comprising:
retrieving information associated with a user of a social networking system associated with a user profile that does not include a relationship status indicating whether the user is single or is not single, the information comprising one or more interactions of the user with one or more additional users of the social networking system;
retrieving user profile information associated with each of the one or more additional users, user profile information associated with an additional user including relationship status information associated with the additional user;
determining a set of values based at least in part on one or more interactions of the user with additional users who are associated with user profiles including information specifying relationship statuses;
calculating a score based at least in part on the set of values; and
inferring the relationship status associated with the user based at least in part on the score.

11. The method of claim 10, wherein calculating the score based at least in part on the set of values comprises:
associating weights with different values in the set of values; and
calculating the score by applying an associated weight to each value in the set of values and combining the values in the set of values after application of the weights.

12. The method of claim 10, wherein inferring a relationship status associated with the user based at least in part on the score comprises:
comparing the score to a plurality of ranges of scores, each range of scores associated with a relationship status; and
inferring the relationship status associated with the user as a relationship status associated with a range of scores including the score.

13. The method of claim 10, wherein determining the set of values based at least in part on one or more interactions of the user with additional users who are associated with user profiles including information specifying relationship statuses comprises:
identifying one or more types of interactions by the user with the one or more additional users of the social networking system as one or more indicators;
determining values for each of the one or more indicators, a value for an indicator based at least in part on a number of additional users associated with the indicator and indicating a relationship status of single and a number of additional users associated with the indicator and indicating a relationship status of other than single.

14. The method of claim 13, wherein the one or more types of interactions by the user are selected from a group consisting of: requesting to establish connections to one or more additional users, accessing user profile information associated with one or more additional users, sending a message to one or more additional users, and any combination thereof.

15. The method of claim 10, wherein calculating the score based at least in part on the set of values comprises:
retrieving the user profile associated with the user;
retrieving information from the user profile associated with the user;
generating one or more additional values based at least in part on the retrieved information from the user profile associated with the user; and
calculating the score based at least in part on the set of values and the one or more additional values.

16. The method of claim 15, wherein the information from the user profile associated with the user is selected from a group consisting of: one or more connections between the user and one or more additional users, content posted to the social networking system in which the user and one or more additional users are identified, relationship statuses associated with one or more additional users connected to the user, a number of users identified in a profile image associated with the user, an age associated with the user, and any combination thereof.

17. The method of claim 15, wherein the information from the user profile associated with the user is selected from a group consisting of: an age associated with the user, a gender associated with the user, one or more ages associated with one or more additional users, one or more genders associated with one or more additional users, one or more relationship statuses associated with one or more additional users, and any combination thereof.

18. The method of claim 10, wherein calculating the score based at least in part on the set of values comprises:
generating the score by applying a machine-learned model to the set of values.

19. The method of claim 10, wherein the relationship status associated with the user based at least in part on the score is selected from a group consisting of: information indicating the user is single and information indicating the user is not single.

20. A computer program product comprising a computer-readable storage medium having instructions encoded thereon that, when executed by a processor, cause the processor to:
retrieve information associated with a user of a social networking system associated with a user profile that does not include a relationship status indicating whether the user is single or is not single, the information comprising one or more interactions of the user with one or more additional users of the social networking system;
retrieve user profile information associated with each of the one or more additional users, user profile information associated with an additional user including relationship status information associated with the additional user;
determine a set of values based at least in part on one or more interactions of the user with additional users who are associated with user profiles including information specifying relationship statuses;
calculate a score based at least in part on the set of values; and
infer the relationship status associated with the user based at least in part on the score.
